(19) United States
(12) Patent Application Publication
(10) Pub. No.: US 2012/0142341 A1
(43) Pub. Date: Jun. 7, 2012

(54) Internetworking Between a Network Capable of Carrying Voice Over Packet Access and a Network Not Capable of Carrying Voice Over Packet Access

(75) Inventors: Ashish Nagpal, Bangalore (IN); Shambhu Dayal Rai, Bangalore (IN)

(73) Assignee: Sonus Networks, Westford, MA (US)

(21) Appl. No.: 13/190,182

(22) Filed: Jul. 25, 2011

(30) Foreign Application Priority Data
Dec. 6, 2010 (IN) 3315/MUM/2010

(51) Int. Cl. H04W 92/02; H04L 12/66; H04W 64/00

(52) U.S. Cl. 455/426.1

(57) ABSTRACT

Systems, methods, and computer program products for interworking messages between a first network capable of carrying voice calls over packet access according to a predetermined criterion and a second network not capable of carrying voice calls over packet access according to the predetermined criterion are disclosed. The location of the user device is determined based on messages received on a plurality of interfaces, and call processing is handled depending on the location of the user device in a first service area of the first network or a second service area of the second network.

### CROSS REFERENCE TO RELATED APPLICATION

This application claims the benefit of and priority to Indian Patent Application No. 3315/MUM/2010 filed Dec. 6, 2010, which is owned by the assignee of the instant application and the disclosure of which is incorporated herein by reference in its entirety.

### TECHNICAL FIELD

The description generally relates to telecommunications systems, methods, networks, and computer program products and more particularly to internetworking messages or communications between a network capable of carrying voice over packet access according to a predetermined criterion and a network not capable of carrying voice over packet access according to the predetermined criterion.

### BACKGROUND

A Long-Term Evolution (“LTE”) network provides a high-performance, over-the-air interface for communication between wireless user devices. The LTE project is the result of a collaboration and standardization effort by the 3rd-Generation Partnership Project (“3GPP”). The specification for an LTE network calls for downlink speeds of at least 100 Megabits-per-second (Mbps) during peak usage and uplink speeds of at least 50 Mbps during peak usage. The specification also calls for round-trip communications with user devices occurring in less than 10 milliseconds. The LTE network is intended to support carrier bandwidths between 1.4-20 MHz. Both time-division duplex and frequency-division duplex calls are also supported. In essence, the LTE network is being designed and engineered to replace the General Packet Radio Service (“GPRS”) core network as a wireless service network. In a GPRS network, the voice calls are carried over a circuit channel (called the circuit-switched core network or access network), and data packets are carried over a packet channel (called the packet-switched core network or access network).

The LTE network, unlike the circuit-switched core network of GPRS, uses an “evolved packet core” for communication of both voice and data packets. When a user device is in a service area of an LTE network, both voice packets and data packets can be reliably communicated to the user device. For voice calls, session initiation protocol (“SIP”) signaling is used to set up and reserve resources for voice calls and real-time transfer protocol (“RTP”) is used to carry the voice content. In contrast, in a radio access network (e.g., a GSM network), SIP and RTP protocols are not used. However, carrying voice packets to a user device over the evolved packet core of an LTE network presents challenges for network designers and carriers.

Because of the inherent difficulties in reliably carrying voice traffic over packet networks, several possibilities for implementing voice-over-LTE networks have developed. In some implementations, operators use an IP Multimedia System (“IMS”) core network to provide voice services over LTE networks. However, due to readiness of the IMS core network, rollout of voice-over-LTE has been delayed, and network operators have sought other approaches for carrying voice calls over the LTE network. For example, some operators have abandoned carrying voice over the LTE network altogether, instead handling calls with the circuit-switched core of existing 2G or 3G wireless networks. Exemplary networks are radio access networks such as, for example, GSM Edge radio access networks (“GERAN”) or UMTS Terrestrial radio access networks (“UTRAN”). This approach is known as circuit-switched fallback. In another example, some mobile network operators have re-used existing mobile switching centers (“MSCs”) for carrying voice over the LTE network via Generic Access (called “VoLGA”). Operators using the VoLGA protocol or approach carry voice calls according to the existing 3GPP Generic Access Network (“GAN”) standard. Another example is the OneVoice initiative, which is a collaboration among industry participants to define a mandatory set of features that a wireless device (e.g., user device) and network must implement to guarantee interoperable, high-quality IMS-based telephony (e.g., voice and data packet carriage) over LTE networks.

Each of these solutions suffers from drawbacks that make them unsuitable for some applications. For example, a drawback of the “circuit-switched fallback” approach is degraded user experience. Call setup is typically delayed when the user device switches between the LTE network and the GERAN/UTRAN network while making or placing a call (e.g., by moving between a service area of the LTE network and a service area of the GERAN/UTRAN network. The length of the delay can be exacerbated because packet-switched sessions between the user device and the LTE network are handed over to the GERAN/UTRAN network. In addition, dropped calls from cell switching occurs more frequently (to the user's detriment) due to the user device moving or switching between the LTE network and the GERAN/UTRAN network. Moreover, movement of the user device between the LTE network and the GERAN/UTRAN network increases the amount of data traffic or messages relating to mobility management between the user device and the mobile switching center (though, this drawback may be alleviated, but not eliminated by implementation of Idle Mode Signaling Reduction (“IMSR”) in the evolved packet core network). Idle Mode Signaling Reduction refers to a feature allowing a user device to toggle between a 3G network and a long-term evolution network without signaling. Finally, circuit-switched fallback does not result in the release of available 2G/3G frequency spectrum, which results in a less efficient use or allocation of spectrum on a calls-per-megahertz basis.

Unlike the circuit-switched fallback approach, the voice over LTE via Generic Access (“VoLGA”) approach does not typically involve drawbacks associated with cell-switching. However, the VoLGA approach typically requires a specific client program, application, or routine to be running on the user device to carry voice calls to a VoLGA-enabled user device. The requirement that the user device include the program, application, or routine is seen as an obstacle to deployment and adoption of the VoLGA approach from the perspective of the carrier and/or the user.

Finally, there are drawbacks to the approach of the OneVoice initiative as well. The current specification for OneVoice calls for deployment of IMS-based infrastructure at roll-out, which results in significant operator cost. The cost occurs both from the roll-out of IMS-based infrastructure and the loss of investment due to reduced use of existing circuit-switched core network components, such as mobile switching centers (“MSCs”). Additionally, coordinating services between IMS-based networks and circuit-switched access networks is generally complex and time-consuming. Finally, in the case of roaming calls, the IMS Centralized Service approach to service consistency is potentially inefficient.

Thus, a non-standardized, scalable approach to intercommunication and facilitating communication of packetized voice calls over an LTE network and determination of location and/or movement of a user device between an LTE network and a radio access network is desirable.

### SUMMARY

The concepts described herein feature an interworking function or module that facilitates seamless intercommunication between a user device and a network capable of carrying voice over packet access and a network not capable of carrying voice over packet access when the user device moves between the two networks. The interworking function or module cooperates with a location-determination module that determines the location and/or the type of network in which the user device is located to facilitate high quality-of-service voice service while leveraging voice over packet access features and capabilities.

Generally, the techniques described here involve determining and/or monitoring the location of the user device. When the user device is in the service area of a network capable of carrying voice calls over packet access (e.g., when the user device is an LTE network), a controller processes the calls for the user device and voice calls are packetized and delivered over packet networks. When the user device moves to the service area of a network not capable or incapable of carrying voice calls over packet access (e.g., a GSM Edge radio access network (“GERAN”) or a UMTS Terrestrial radio access network (“UTRAN”) network) or carrying voice packets with low or unacceptable quality-of-service, the controller hands off call processing to a mobile switching center in communication with the second network for processing voice calls and for communicating voice calls to the user device over circuit-switched access networks. GSM refers to the “Global System for Mobile Communications” protocol, and UMTS refers to the “Universal Mobile Telecommunications System.” After the handoff to the mobile switching center, the signaling connection to the user device (e.g., SIP signaling) is maintained. Various architectures and equipment can be used to implement location determination and call processing depending on the location and/or movement of the user device. Additionally, the techniques described here allow network operators to implement mobility-management features and functions in the network to service wireless devices.

Typically, an operator deploying a mixed LTE/radio access network (such as a GERAN or UTRAN network) requires voice calls be established over a packet-switched access network with the user device when the user device is in the service area of the LTE network and over a circuit-switched access network when the user device is in the service area of the radio access network (e.g., the GERAN/UTRAN network). The concepts described here address movement of the user device between the LTE network and the GERAN/UTRAN network. In some implementations, the techniques involve deployment of a specialized or specially-programmed standard network element. In some embodiments, the network element is a session-initiation-protocol (“SIP”) base station controller (“BSC”). The SIP-BSC monitors the location of the user device by examining signaling messages to or from the user device on one or more network interfaces. When the user device is in the service area of the LTE, the SIP-BSC handles call processing for the user device. When the user device moves to the service area of the GERAN/UTRAN network, the SIP-BSC communicates with a mobile switching center (e.g., a legacy mobile switching center) to identify the location of the user device in the service area of the MSC's network and/or to instruct the MSC to handle or process calls to the user device rather than handling calls with the SIP-BSC.

The techniques described here employ an “interworking function” or an internetworking or interworking module. The interworking module, in some implementations, communicates with a standard IMS-based SIP client on a terminal or node in a long-term evolution or voice-over-broadband network. The interworking module interworks communications from the LTE/VoBB network to legacy mobile switching centers using standardized Iu/A links. In this way, the interworking module allows operators to leverage existing investments in the circuit-switched access core. Moreover, the interworking module in cooperation with the location determination module evaluates the location of the user device based on information from one or more network interfaces. Information from more than one interface can be aggregated and/or used to verify or improve the reliability of the determined information. The location of the user device can beneficially be used to improve mobility management functions and/or services provided to the user or user device.

In one aspect, there is a telecommunications system. The system includes a controller that is in communication with a first network and a second network. The first network is capable of carrying voice calls over packet access according to a predetermined criterion (or one or more criteria). The second network is not capable or incapable of carrying voice calls over packet access according to the predetermined criterion (or criteria). The system also includes an interworking module in communication with the first and second networks. The interworking module facilitates communication of signaling messages between the first and second networks. The system includes a location-determination module in communication with the controller and the interworking module. The location-determination module determines when a user device is in a service area of the first network and when the user device is in a service area of the second network based on the signaling messages.

An example of a predetermined criterion applicable to any of the aspects described here is a quality-of-service parameter associated with a network and/or the network's capability of carrying voice over packet access reliably. Another example of a suitable predetermined criterion is a network operator policy permitting voice over packet access within the operator's network. Conversely, those of skill will understand that an operator policy prohibiting voice over packet access in the operator's network can also be associated with the predetermined criterion. Some implementations feature multiple criteria indicative of the capability of a particular network to carry voice over packet access (e.g., both a quality-of-service parameter and a network operator policy).

In some embodiments, the system includes a session-initiation-protocol interface in communication with the location determination module and the user device. The location determination module can determine the location of the user device based on session-initiation-protocol (“SIP”) messages. The location determination module, in some implementations, determines the user device is located in the service area of the first network based on a plurality of messages that use one or more communications protocols or based on messages received on one or more interfaces in the first or second networks. The location determination module can be in communication with the one or more interfaces, which can include, for example, an intermediary SIP node, an interface with a mobility management entity node in a packet-based access network, an interface with a Home Location Register/Home Subscriber Server (“HLR/HSS”) node in an IP Multimedia Subsystem (“IMS”)-type network, an interface with a Policy and Charging Rules Function (“PCRF”) node in a packet network, or a combination of these. Some implementations feature at least one of a SIP interface, an Rx interface, an Sh interface, an SGs interface, an SLg interface, a non-standard interface, or any combination of these interfaces.

Some embodiments feature the location determination module determining the user device is located in the service area of the first network based on a SIP registration, a radio access technology registration (“RAT-type”), or a combination of these. The interworking module can translate messages between a packet-based format and a circuit-based format based on whether the user device is in the service area of the first or second network. The second network can, for example, be capable of carrying voice calls over circuit access. The location-determination module, in some embodiments, tracks movement of the user device between the service areas of the first or second networks. The controller can include the location-determination module (and/or the interworking module).

In some implementations, the first network includes a packet-switched access network and the second network includes a circuit-switched access network, a packet-switched access network or both. The first network can be or include a long-term evolution network, and the second network can be or include a circuit-switched core network. A circuit-switched core network can include or be in communication with a 2G/3G GSM core network, a GSM Edge network (“GERAN”), a UMTS terrestrial network (“UTRAN”), an enhanced UTRAN (“E-UTRAN”), or any combination of these networks.

Some embodiments feature a mobile switching center in a 2G/3G GSM core network for providing voice packets and data packets to the user device in the service area of the second network. The mobile switching center can be in communication with the interworking module. The system can also include an application server in communication with the controller (or logically associated with the controller). An exemplary application server is an IP Multimedia Subsystem (“IMS”) application server.

In another aspect, there is a method for routing telecommunications data including voice packets and data packets between a controller and a user device. The method involves receiving data from the user device. The method also involves determining, based on one or more signaling messages, whether the user device is located in a first service area of the first network (capable of carrying voice calls over packet access according to a predetermined criterion) or in a second service area of the second network (not capable or incapable of carrying voice calls over packet access according to the predetermined criterion). The method involves interworking signaling messages between the first and second network and exchanging voice packets with the user device when the user device is located in the first service area of the first network. The method also involves transmitting data packets (and/or voice packets) to a mobile switching center when the user device is located in the second service area of the second network. The data packets can be communicated to the user device over the second network.

In some embodiments, the method involves implementing mobility management functions when the user device is determined to be in the first service area of the first network. The method can involve monitoring a location of the user device. Monitoring involves, in some implementations, periodically examining data from the user device, determining, based on the periodically-examined data, whether the user device has moved between the first and second service areas of the respective first and second networks, and storing the location of the user device in a memory (though, in some implementations, the storing step is optional). Storing can involve identifying or storing an identification of an interface on which the data was received.

Some implementations involve sending an update message to the second network (or a component thereof, such as a mobile switching center) when the user device is determined to have moved between the first and second service areas of the respective first and second networks. Monitoring the location of the user device can involve querying a network element capable of communicating with the user device. In some embodiments, the exchanging step involves emulating the mobile switching center. In some embodiments, the first network includes a long-term evolution network, and data packets, voice packets, or both are exchanged with the user device according to a SIP protocol. The second network can include (or be) a radio access network.

The method can involve verifying the location of the user device based on a plurality of messages received from the user device (on one or more interfaces). Such verification can also be referred to as aggregation of location information. Some embodiments of the method involve determining whether the user device has moved from the second service area of the second network to a third service area of a third network that is likewise not capable or incapable of carrying voice calls over packet access according to the predetermined criterion without first moving to the service area of the first network. Determining whether the user device has moved to the third service area involves, in some implementations, analyzing messages received from the user device or at least one interface. Exemplary interfaces include at least one of an intermediary SIP node, an interface with a mobility management entity (“MME”) node in a packet-access network, an interface with an HSS/HLR node or element in an IMS-type network, an interface with a PCRF node or element in a packet network, or any combination of these.

In yet another aspect, there is a computer program product tangibly embodied in a non-transitory computer-readable storage medium containing instructions operable to cause data processing apparatus to receive data from a user device. The instructions are also operable to cause data processing apparatus to determine whether the user device is located in a first area of a first network capable of carrying voice calls over packet access according to a predetermined criterion or in a second service area of a second network not capable or incapable of carrying voice calls over packet access according to the predetermined criterion. The determination is based on one or more signaling messages. The instructions are also operable to cause data processing apparatus to interwork signaling messages between the first and second networks and exchange voice packets with the user device when the user device is located in the first service area of the first network.

In another aspect, there is a computer-implemented telecommunications system. The system includes an interface means for receiving at least one of voice data or packet data from a user device. The system includes a location-determination means for determining when the user device is located in a first service area of a first network capable of carrying voice calls over packet access according to a predetermined criterion and when the user device is located in a second service area of a second network not capable or incapable of carrying voice calls over packet access according to the predetermined criterion. The location-determination means also determines when the user device has moved from the second service area to a third service area of a third network not capable or not capable of carrying voice calls over packet access according to the predetermined criterion. The system includes a means for interworking signaling messages between the first, second, and third networks, a circuit-switched core network, or any combination of these. The system includes a means for receiving location updates associated with the user device. The location updates include a location of the user device or a movement of the user device between the first service area and the second or third service areas of the respective first, second, or third networks. The system also includes a means for exchanging voice packets with the user device when the user device is located in the first service area of the first network.

Any of the above aspects can include any of the above embodiments. In one implementation, any of the above aspects includes the features of each of the embodiments.

These and other features will be more fully understood by reference to the following description and drawings, which are illustrative and not necessarily to scale.

### BRIEF DESCRIPTION OF THE DRAWINGS

FIG. 1 is a plan view of an exemplary telecommunication network for internetworking signaling and other messages between a first network and a second network.

FIG. 2 is a partial perspective view of an exemplary telecommunications network illustrating intercommunication between network components to facilitate internetworking of signaling messages.

FIG. 3 is a flow chart describing a general process flow for internetworking between a network capable of carrying voice over packet communications and a network not capable of carrying voice over packet communications.

### DETAILED DESCRIPTION

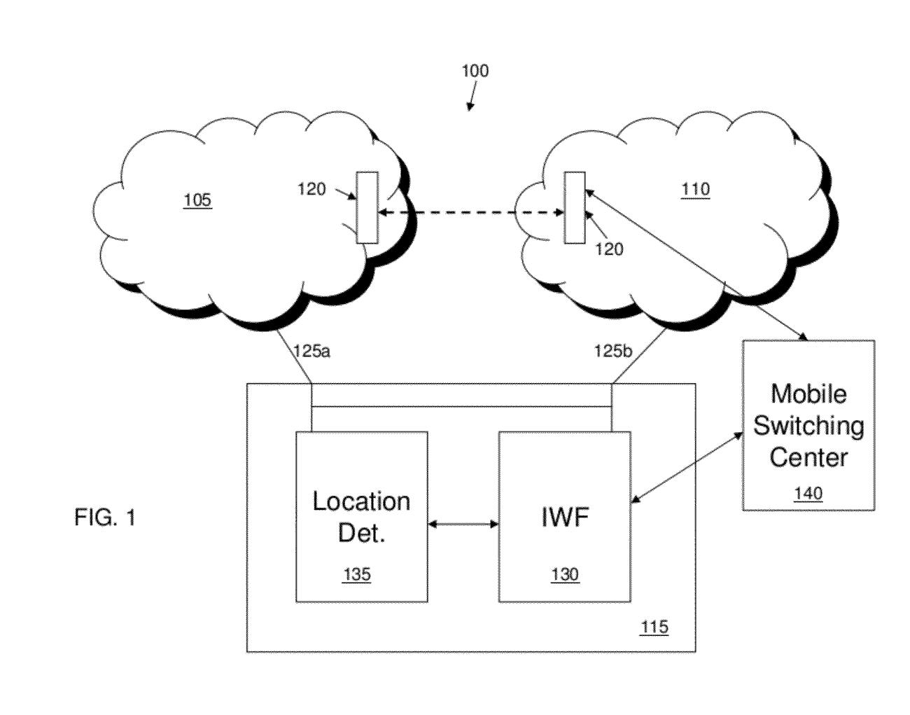

FIG. 1 is a plan view of an exemplary telecommunication network 100 for internetworking signaling and other messages between a first network 105 and a second network 110. In addition to the first network 105 and the second network 110, the network 100 includes a controller 115. The first network 105 is a network capable of carrying voice over packet access according to a predetermined criterion (or criteria) within a service area (not shown) of the first network 105. An example of the network 105 is a long-term-evolution network. The second network 110 is a network that is not capable or incapable of carrying voice over packet access according to the predetermined criterion (or criteria) within a service area (not shown) of the second network 110. An example of the second network 110 is a radio access network such as, for example, a GSM Edge radio access network (“GERAN”) or a UMTS Terrestrial radio access network (“UTRAN”).

An example of a predetermined criterion associated with whether the first network 105 and/or the second network 110 is capable of carrying voice over packet access is a quality-of-service parameter associated with the network 105, 110 and/or the network's 105, 110 capability of carrying voice over packet access reliably. Another example of a suitable predetermined criterion is a network operator policy permitting voice over packet access within the operator's network 105, 110. Some implementations feature multiple criteria indicative of the capability of a particular network to carry voice over packet access (e.g., both a quality-of-service parameter and a network operator policy). As illustrated, the network 105 satisfies the predetermined criterion because the quality-of-service parameter exceeds an acceptable value for reliably carrying voice over packet access and/or because the operator of the network 105 has implemented a policy permitting voice over packet access within the network 105. The network 110 does not satisfy the predetermined criterion either because the quality-of-service parameter does not exceed an acceptable value for reliably carrying voice over packet access or, even if the quality-of-service parameter is satisfied, because the operator of the network 110 has implemented a policy not permitting or prohibiting voice over packet access within the network 110.

A user device 120 can move between the first network 105 and the second network 110 (and service areas thereof). The user device 120 can be an IMS-based wireless device that communicates (or is capable of communicating) using session initiation protocol (“SIP”) messages. In some implementations, the user device 120 is a standard SIP/IMS user device. The user device may include other features or services as well (e.g., PDA-type features or internet-related features). In some embodiments, the same network operator administers, manages, or operates the first network 105 and the second network 110. Different and unrelated or unaffiliated network operators can administer, manage or operate the first network 105 and the second network 110 in some implementations.

The controller 115 is in communication with the first network 105 and the second network 110 via communication paths 125a-125b, respectively. Communication paths 125a-125b can be wired or wireless connections between the controller 115 and one or more components in the first network 105 or second network 110 or between the controller 115 and the user device 120. The communication paths 125a-125b facilitate intercommunication of information (e.g., voice calls, voice packets, data packets, signaling messages, or any combination of these) between the controller 115 and the networks 105, 110 or the user device 120.

The controller 115 is in communication with an interworking function (“IWF”) module 130 and a location determining module 135. The IWF module 130 communicates with the location determining module 135 and vice versa. In some embodiments, the controller 115 includes the IWF module 130 and/or the location determining module 135. For example, the controller 115 and the IWF module 130 and/or the location determining module 135) can be associated with the same network address or point code. In some embodiments, the controller 115 is a base station controller augmented with functionality, described herein, to facilitate communication with the user device 120 regardless of whether the user device 120 is in the service area of the first network 105 or the service area of the second network 110. The controller 115 can be considered a node in the network 100 (or of the first network 105 or the second network 110). Some embodiments feature the controller 115 performing additional telephony functions such as, for example, SIP registration, Proxy-Call Session Control Functions (“P-CSCF”), media gateway functions, or combinations of these, in addition to providing interworking of signaling messages and/or location-determination functions.

In some implementations, the controller 115 is the node of the network 100 responsible for interworking or intercommunicating voice calls and data packets (e.g., short-message service or SMS packets) with the user device 120. The controller 115 can include an application server (not shown) portion or component or can be in communication with an application server. At a high level, the controller 115 determines or learns the location of the user device 120 based on messages (e.g., signaling messages) received from the user device 120, e.g., over communication channel 125a when the user device 120 is in the service area of the first network 105 and over communication channel 125b when the user device 120 is in the service area of the second network 110. As will be described in more detail below, the location-determining module 135 determines the location of the user device 120 (e.g., whether the user device 120 is in the service area of the first network 105 or the second network 110) by examining messages received on a variety of interfaces (not shown) and associated with either the first network 105 or the second network 110. The communication channels 125a-125b can include one or more of these interfaces. When the location determination module 135, upon examining signaling messages received from the user device 120, determines the user device 120 is in the service area of the second network 110, the IWF module 130 communicates with a mobile switching center 140 to allow the mobile switching center 140 to process voice calls and data packets for the user device 120. The controller 115 maintains a SIP signaling channel of the first network 105 with the user device 120 to allow the user device 120 to seamlessly switch back to service from the first network 105 when the user device 120 reenters a service area of the first network 105.

The controller 115 is, in some embodiments, involved in call processing when the user device 120 is in the service area of the first network 105. When the user device 120 is in the service area of the second network 110, the mobile switching center 140 is involved in call processing on behalf of the user device 120. When the controller 115 determines the user device 120 has moved from the service area of the second network 110 to the service area of the first network 105, the controller (e.g., via the IWF module 130) sends a communication to the mobile switching center 140 to indicate the controller 115 will handle call processing while the user device 120 is in the service area of the first network 105. In some embodiments, the communication from the controller 115 to the mobile switching center 140 is a location update message.

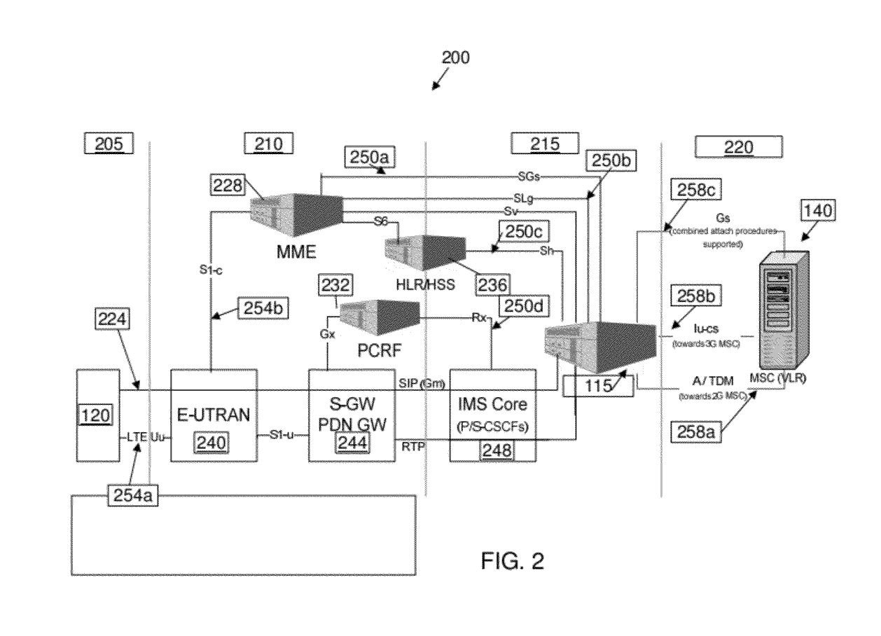

FIG. 2 is a partial perspective view of an exemplary telecommunications network 200 illustrating intercommunication between network components to facilitate internetworking of signaling messages. The network 200 is depicted as logically segregated into a user-device segment 205, a packet-core network segment 210, an IMS network segment 215, and a circuit-switched core network segment 220.

The user-device segment 205 includes the user device 120 of FIG. 1, as a network element and/or network node. The user device 120 communicates with the controller 115 of FIG. 1, which resides in the IMS network segment 215. The user device 120 communicates with the controller 115 via a session initiation protocol (“SIP”) communication channel 224 for communication of signaling messages. The controller 115 determines the location of the user device 120 from communications from the user device 120 through components of the packet-core network segment 210 and the IMS network segment 215.

The packet-core network segment 210 is, in some embodiments, an evolved packet core network. The packet-core network segment 210 includes a mobility management entity (“MME”) 228 and a Policy and Charging Rules Function (“PCRF”) element 232. A Home Location Register/Home Subscriber Server (“HLR/HSS”) element 236 interfaces between the packet-core network segment 210 and the IMS network segment 215. The HLR/HSS element 236 can reside at or act as an interface between the segments 210, 215. The packet-core network segment 210 also includes an Evolved Universal Terrestrial Radio Access Network (“E-UTRAN”) component 240 and a gateway component 244. The gateway component 244 can be a media gateway, a signaling gateway, a packet data network gateway, or a hybrid gateway including any combination of these functionalities. The IMS network segment 215 includes an IMS Core component 248. The IMS Core component 248 includes Proxy/Server-Call Session Control Function (“P/S-CSCFs”) module.

The network 200 includes several interfaces 250a-250d from which the controller 115 can determine the location of the user device 120. The controller 115 can also determine the location of the user device 120 from communications received over the communication channel 224. In some embodiments, the communication channel 224 is an interface to the user device 120. The interfaces 250a-250d can also be an interface to the user device 120 via components in the packet-core network segment 210, the IMS network segment 215, or both. The interfaces 250a-250d and location determination from the communication channel 224 are described in detail below.

The user device 120 can communicate with the controller 115 using the communication channel 224, for example, when the user device 120 is an IMS-enabled device. The communication channel 224 interfaces with the E-UTRAN component 240, the gateway component 244, and the IMS Core component 248. The IMS specifications provide that IMS-based communications include a packet header and the “cell-ID” in which the user device 120 is located. The header is referred to as a P-Access-Network-Info header and is sent with SIP communications (e.g., requests and responses) to the controller 115 after the controller 115 (or other network component, not shown) establishes a security association with the user device 120. By examining the “cell-ID,” the controller 115 (e.g., via the location determination module 135 of FIG. 1) determines the user device 120 is within a service area of a network capable of carrying voice calls over packet access. For example, the controller can compare the cell-ID received from the user device 120 to a lookup table or other storage mechanism associating a particular cell-ID with the network or an indication that the network is capable of carrying voice calls over packet access according to a predetermined criterion (e.g., either a quality-of-service parameter or the network operator's policy regarding voice over packet access within the network).

An exemplary call-flow for determining the location of the user device 120 using the communication channel 224 follows. When the user device 120 is in the service area of a network that supports SIP communication, the user device 120 communicates with an access network using data packets that include a packet header. SIP communication requests specify a P-Access-Network-Info header. The controller 115 examines the P-Access-Network-Info header to determine if the user device 120 is within the service area of a network that supports SIP communication. More specifically, the controller 115 checks to see if the “access type” field in the P-Access-Network-Info header is set to “3GPP-E-UTRAN-FDD” or “3GPP-E-UTRAN-TDD,” and if so, the controller 115 sets a “utran-cell-id-3gpp” parameter to concatenate information including the cell identity. Thus, from this SIP message, the controller 115 can determine if the user device 120 is within a network that supports voice over packet access. The controller 115 can examine, evaluate, and/or update other information in the P-Access-Network-Info header such as, for example, MCC, MNC, or TAC data. Additionally, the location of the user device 120 can be determined from an authorization header in a SIP communication, based on the invite and response communications by deriving the location from a packet header (rather than the routine SIP communications after a SIP session is established).

In some embodiments, the user device 120 is a circuit-switched-fallback (“CSFB”)-enabled device. A CSFB-enabled device can “attach” itself to an E-UTRAN network, e.g., via E-UTRAN network component 240, via communication over an LTE Uu interface 254a. The E-UTRAN network component 240 communicates with the mobility management entity 228 (e.g., via an S1-c interface 254b). In some implementations, the user device 120 attaches to the E-UTRAN network component 240 via a combined Evolved Packet System/International Mobile Subscriber Identity (“EPS/IMSI”) attachment process. Upon the user device 120 attaching to the E-UTRAN network, the mobility management entity 228 communicates, over an SGs interface 250a, the attachment and information associated with the attachment to the controller 115. The controller 115, in turn, determines the user device 120 is attached to a segment of the packet-core network segment 210, and therefore, is within a service area of a network capable of carrying voice over packet access. With the SGs interface 250a, the mobility management entity 228 informs the controller 115 when the user device 120 has moved from a GERAN/UTRAN network to an E-UTRAN network. When the user device 120 has moved from an E-UTRAN network to a GERAN/UTRAN network, the mobility management entity 228 does not provide a communication to the controller 115.

For example, the mobility management entity 228 communicates location and network attach/detach information associated with the user device 120 to the controller 115 (e.g., the location determination module 135 or the interworking module 130). In a detailed embodiment, the mobility management entity 228 sends an SGsAP-LOCATION-UPDATE-REQUEST message to the controller 115, requesting an update as to the location of the user device 120 and/or to request information regarding the IMSI status and/or network attach status or location information. The mobility management entity 228 can also send an SGsAP-EPS-DETACH-INDICATION or SGsAP-IMSI-DETACH-INDICATION message to the controller 115 to indicate the user device 120 associated with a specified IMSI status is detached from a network.

The controller 115 evaluates the messages from the mobility management entity 228 and communicates the location and/or attachment status of the user device 120 to the mobile switching center 140 in the circuit-switched core network segment 220. The controller 115 can communicate messages, on behalf of the mobile switching center 140, to the mobility management entity 228, based on information the controller 115 receives from the mobile switching center 140. For example, the controller 115 can communicate SGsAP-LOCATION-UPDATE-ACCEPT or SGsAP-LOCATION-UPDATE-REJECT messages in response to SGsAP-LOCATION-UPDATE-REQUEST messages from the mobility management entity 228.

In some embodiments, the controller 115 obtains from the mobility management entity 228 (e.g., via communication) over an SLg interface 250b. The controller 115 acts as or emulates a gateway mobile location center (“GMLC”), from the perspective of the mobility management entity 228. The mobility management entity 228, in turn, provides location information for the user device 120 to the controller 115 emulating a GMLC.

For example, the controller 115 can take advantage of its emulation of the GMLC to learn the location of the user device 120 over the interface 250b. The evolved packet core location services protocol (“ELP”) can be used with the interface 250b to determine the location of the user device 120. The controller 115, acting as a GMLC, can query the mobility management entity 228 with a PROVIDE SUBSCRIBER LOCATION REQUEST, to which the mobility management entity 228 communicates a PROVIDE SUBSCRIBER LOCATION RESPONSE with an estimate of the location of the user device 120. The PROVIDE SUBSCRIBER LOCATION REQUEST requests the mobility management entity 228 to provide the location of the user device 120 based on the user device's 120 International Mobile Subscriber Identity (“IMSI”).

Some embodiments feature the mobility management entity 228 initiating the location procedure by sending a SUBSCRIBER LOCATION REPORT to the controller 115. The SUBSCRIBER LOCATION REPORT includes the identity of the user device 120 and an estimate of the location of the user device 120 (e.g., the network to which the user device 120 is attached). The controller 115 examines the location estimate to determine whether the user device 120 is within the service area of a network that supports voice over packet access.

The controller 115 can obtain location information about the user device 120 over an interface 250c to the HLR/HSS element 236. For example, the controller 115 acts as or emulates an application server (e.g., an IMS application server) to retrieve information about the location of the user device 120 from the HLR/HSS element 236. An example of the information the controller 115 can obtain is Terminating Access Domain Selection (“T-ADS”) information from the HLR/HSS element 236. T-ADS information, in turn, contains information associated the radio access technology (“RAT”)-type that is serving the user device 120 and/or whether voice over packet access or packet-switched access is supported. The controller 115 can, based on the RAT-type serving the user device 120, determine whether the user device 120 is within a service area of a network capable of carrying voice over packet access (e.g., by comparing the RAT-type in the packet to values stored in a list or look-up table).

For example, the controller 115 can request T-ADS information from the HLR/HSS element 236 using an “Sh-Pull procedure” defined in 3GPP Technical Specification TS 29.328. Upon receiving the request from the controller 115, the HLR/HSS element 236 can query the mobility management entity 228 to determine the T-ADS information of the user device 120. In some embodiments, the HLR/HSS element 236 determines voice over packet access is not supported without querying the mobility management entity 228 and provides a communication to the controller 115 indicating voice over packet access is not supported in the service area in which the user device 120 is located. The HLR/HSS element 236 responds to the controller's 115 “Sh Pull” request over the interface 250c with the T-ADS information associated with the user device 120. The response can comply with the TS 29.328 specification and include, for example, “RAT type” and “IMS voice over PS Session supported” status in the access network, as communicated to the controller 115. Based on the response of the HLR/HSS element 236, the controller can determine the location of the user device 120. In some embodiments, the controller saves and/or stores the “RAT type” and “IMS voice over PS Session supported” status.

In some embodiments, the controller 115 determines the location of the user device 120 using an Rx interface 250d. The interface 250d facilitates communication between a Policy and Charging Rules Function (“PCRF”) element 232 and a Proxy-Call Session Control Function (“P-CSCF”) element 248. The P-CSCF element 248 subscribes to the PCRF element 232, via communication over the Rx interface 250d, to receive communications or notifications regarding the user device 120. For example, the PCRF element 232 will provide the P-CSCF element 248 with Internet Protocol-Connectivity Access Network (“IP-CAN”) notifications or notifications when the user device's 120 RAT-type changes (which information the PCRF element 232 learns based on communications from the user device 120). In some implementations, the PCRF element 232 communicates changes in IP-CAN or RAT-type data associated with the user device 120 to the controller 115 using SIP messages or combinations of SIP and Session Description Protocol (“SDP”) messages. In some embodiments, the controller 115 subscribes directly to the PCRF element 232, via the Rx interface 250d, to receive communications from the PCRF element 232 (rather than through the P-CSCF element 248).

For example, the PCRF element 232 can receive updates from the packet core segment 210 and maintains the status of network resources allocated for bearer channels. The controller 115 can, in turn, examine the allocation information of the PCRF element 232 to determine the “network attach” status of the user device 120. In some implementations, the controller 115 acts as an Application Function (“AF”) and determines or obtains the IP-CAN and/or RAT-type information about the user device 120 from the PCRF element 232. In some implementations, the P-CSCF element 248 acts as the Application Function (“AF”) and communicates with the PCRF element 232 to determine or obtain the IP-CAN and/or RAT-type information about the user device 120 from the PCRF element 232. The P-CSCF element 248 then communicates the received information to the controller 115 (e.g., or the interworking module 130).

In an exemplary process flow, the user device 120 communicates a SIP REGISTER request to the P-CSCF element 248, which in turn communicates a SIP REGISTER request to the controller 115 acting as an Application Function. The controller 115 acknowledges the SIP REGISTER request to the P-CSCF element 248, which in turn acknowledges the request to the user device 120. In this way, the SIP registration procedure is completed, resulting in the user device 120 being authenticated and/or registered with the IMS-based network segment 215. Next, the controller 115 or the P-CSCF element 248 requests establishment of a new Diameter Rx session by sending a Diameter AAR command to the PCRF element 232. The Diameter Rx session subscribes to the status of an IMS signaling path. The PCRF element 232 establishes a session (called “session binding”) and reserves resources for the SIP session based on, for example, established rules related to IMS signaling. The PCRF element 232 then confirms the subscription to IMS signaling and responds with a Diameter AAR message to the controller 115 or P-CSCF element 248 in response. Upon the PCRF element 232 learning of changes (either by receiving a communication or determining a change has occurred, e.g., via periodic update) in the IP-CAN or RAT-type associated with the user device 120, the PCRF element 232 communicates the change to the controller 115 or P-CSCF element 248. The controller 115 uses the information received directly from the PCRF element 232 or via the P-CSCF element 248 to determine the location of the user device 120. The controller 115 can also use the received information to determine the user device has moved between networks, e.g., from an LTE network to a GERAN/UTRAN network or from one GERAN/UTRAN network to another GERAN/UTRAN network.

In some embodiments, the controller 115 uses information from more than one interface 250a-250d or the communication channel 224 to determine the location of the user device 120 more reliably. In some embodiments, the network 200 does not include or does not employ all of the interfaces 250a-250d or the communication channel 224 described here.

After the controller 115 has determined the location of the user device 120, the controller 115 can take further action in support of intercommunication or to provide telecommunications services. For example, if the user device 120 is in the service area of a network capable of carrying voice over packet access, the controller 115 can handle call processing for the user device 120. If, on the other hand, the controller 115 determines the user device 120 is in the service area of a network that is not capable of carrying voice calls over packet access, the controller 115 can interwork the signaling messages received from the user device 120 to facilitate communication between the user device 120 and the mobile switching center 140. Thus, to the mobile switching center 140, the controller 115 appears as (or emulates) the user device 120 for purposes of call processing. The controller 115 can communicate with the mobile switching center 140 using interface links 258a-258c, depending on the type and/or nature of the mobile switching center 140.

In embodiments in which the mobile switching center 140 is a node in a 2G wireless network, the controller 115 can communicate with the mobile switching center 140 using an interface link 258a. The interface link 254a can be an A-link-over-TDM link. In embodiments in which the mobile switching center 140 is a node in a 3G wireless network, the controller 115 can communicate with the mobile switching center 140 using an interface link 258b. The interface link 258b can be an Iu-CS-over-ATM or IP link. Iu-CS generally refers to an “interface, circuit-switched.” In embodiments involving combined “attach” procedures or processes by which the user device 120 identifies itself to a network and requests services, the controller 115 can communicate with the mobile switching center 140 using a Gs interface link 258c.

The interworking module 130 of the controller 115 facilitates intercommunication between the user device 120 and the mobile switching center 140. For example, for voice calls and/or data packets (such as SMS messages), the controller 115 receives SIP communications and translates (e.g. by analyzing and reformatting) the communications according to and/or based on an interface 258a-258c the mobile switching center 140 understands. Similarly, for communications the controller 115 receives from the mobile switching center 140 over the interfaces 258a-258c, the controller 115 translates the messages to a SIP communications protocol before transmitting to the user device 120 via the packet core network segment 210 or the IMS-based network segment 215 (e.g., on communication channel 224).

In some embodiments, information about the user device 120 is used to implement mobility management functions. For example, the location of the user device 120, the access network's RAT-type, and/or SIP registration information can be used to facilitate mobility management-related messages and procedures. Examples of mobility management functions include updates regarding the location and/or attachment status of the user device 120 that are provided to the mobile switching center 140 over the interfaces 258a-258c. For example, the controller 115 sends a LOCATION UPDATE REQUEST to the mobile switching center 140 to provide the location of the user device 120 when the user device 120 moves into a service area of a network that supports voice over packet access, when the user device 120 moves from a service area of a network that supports voice over packet access to the service area of a second network that also supports voice over packet access, and/or when the user device is turned on (e.g., by starting up or enabling network connectivity) and attaches to a network that supports voice over packet access. The controller 115 can also communicate an IMSI DETACH INDICATION message to the mobile switching center 140 when the user device 120 detaches from a network that supports voice over packet access. For example, when the controller 115 or the interworking module 130 receives a “DETACH” indication over the SGs interface 250a, the “detached” status can be communicated to the mobile switching center. Other location updates and/or messages will be apparent to those of skill.

The controller 115 can dynamically update (and/or delete) information associated with the user device 120 based on information from the communication channel 224 or the interfaces 250a-250d. The table below sets forth exemplary information associated with the user device 120 the controller 115 can determine and/or update.

| Information | | |
|---|---|---|
| Parameter | Parameter Meaning | Possible Values |
| SIP Contact | Registered contract address | Numerical |
| | (or transport address) to | address value |
| | reach the user device 120 | |
| | for SIP signaling. The | |
| | controller 115 adds, | |
| | deletes, or updates this | |
| | parameter based on SIP | |
| | registration and expiration | |
| | procedures | |
| Network Access/ | The access network the | Detached |
| RAT-type | user device 120 is using | 3GPP-E-UTRAN-FDD |
| | | 3GPP-E-UTRAN-TDD |
| | | 3GPP-GERAN |
| | | 3GPP-UTRAN-FDD |
| | | 3GPP-UTRAN-TDD |
| Location | The location of the user | LAI (Location Area |
| | device 120 | Identity) |
| | | GCID (Global Call ID) |

With respect to the “Network Access/RAT-type” parameter, the controller 115 updates the value based on the latest information received on the communication channel 224 or the interfaces 250a-250d. The “Location” parameter is determined from the communication channel 224 or the interfaces 250a-250d. Exemplary values of the “Location” parameter include E-UTRAN GCID (in a P-Access-Network-Info header), GERAN GCID or LAI information received over SGs interface 250a (as a “location update”) or SLg interface 250b (as a “location report”).

Upon determining the “Location” information, as discussed above, the controller 115 can provide a location update to the mobile switching center 140. For example, when the controller 115 determines the user device 120 is in the service area of a network that supports voice over packet access such as a long-term evolution network, the controller provides location updates to the mobile switching center 140. The controller 115 can, for example, provide the RAT-type of the access network to which the user device 120 is attached (e.g., from the “Network Access/RAT-type” field) or information indicating the user device 120 is within an LTE network. The controller 115 can also communicate to the mobile switching center 140 that the controller 115 is maintaining an active SIP registration associated with user device 120. As described above, the controller 115 communicates location updates to the mobile switching center 140 using the interfaces 258a-258c.

When the controller 115 determines the user device 120 is no longer within a service area of a network capable of supporting voice over packet access (e.g., a GERAN/UTRAN network), the controller 115 sends a communication to the mobile switching center 140. An example of such a communication is an IMSI DETACH INDICATION. The controller 115 also updates its records to indicate the user device 120 is “detached.”

In some networks, Idle Mode Signaling Reduction (“ISR”) is enabled. ISR refers to a feature allowing the user device 120 to toggle between a 3G network and a long-term evolution network without signaling. The techniques described here intercept signaling messages to and from the user device 120 to determine the location of the user device 120 (e.g., and movement from one network type to another. The ISR feature can be disabled to facilitate improved operation of the location determination techniques described (e.g., to assure signaling messages can be received and evaluated). However, the techniques described can be used when ISR operation is enabled except that certain messages (e.g., messages received over the communication channel 224) may not be available for determining movement between networks. In such implementations, the controller 115 can evaluate and examine communications received from other interfaces (e.g., the interfaces 250a-250d) for determining the location of the user device 120.

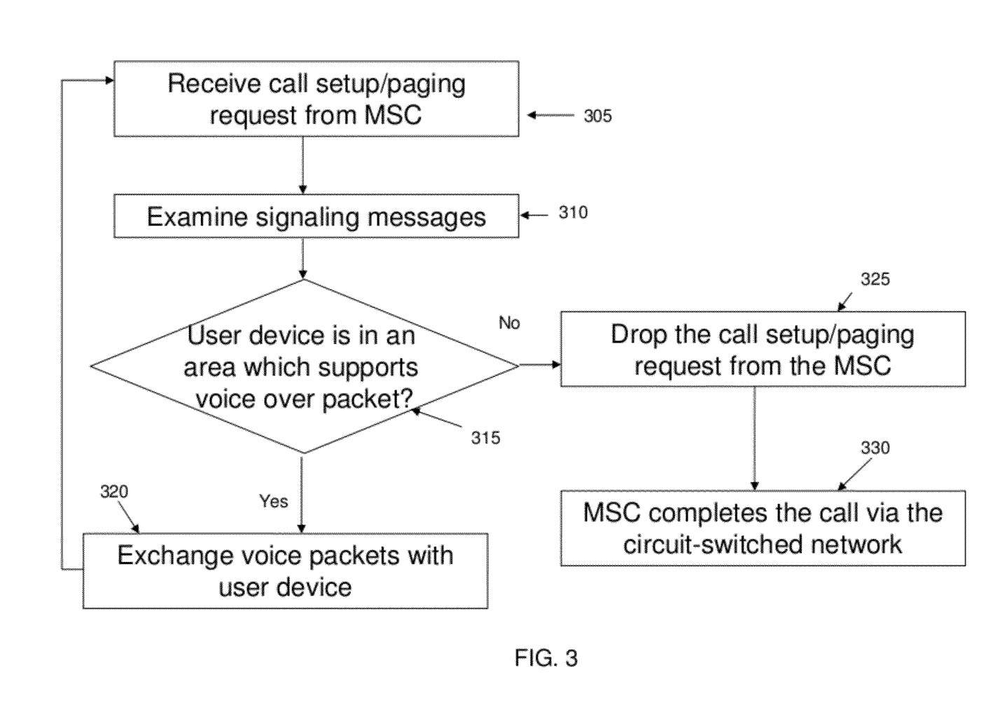

FIG. 3 a flow chart 300 describing a general process flow for internetworking between a network capable of carrying voice over packet communications and a network not capable of carrying voice over packet communications. The method involves receiving a call setup or paging request from a mobile switching center (step 305), for example, the mobile switching center 140 of FIGS. 1-2. The request can be based on a communication from a user device, e.g., the user device 120 of FIGS. 1-2. The information can be received directly from the user device or via intervening and/or intermediate network elements or interfaces. After the request is received, the signaling messages associated with the user device, mobile switching center, and/or the request are examined and/or analyzed (step 310). Step 310 involves examining the type of network the user device is currently using or attached to, e.g., by examining the signaling messages or values/elements/data in fields within the signaling messages. For example, step 310 can involve examining whether the user device is within the service area of a long-term evolution network or a radio access network (or neither). After the type of network (or service area) has been determined, the method involves determining whether the determined type of network supports voice calls over a packet-access network according to a predetermined criterion (step 315). This determination can involve comparing a network type to a list or look-up table that associates network-types with their suitability or capability of supporting voice over packet access or whether voice over packet access is permitted or prohibited. Additionally, the criterion (or criteria) can be associated with network operator policy (e.g., permitting or prohibiting voice calls over packet access), a performance characteristic of the network (e.g., an established latency of packet delivery or bandwidth allocated for voice packets), a network design (e.g., priority tags with voice packets), or a combination of these criteria. If voice calls over packet access are supported, the type of network information is stored and voice and/or data packets are exchanged with the user device (step 320). For example, steps 305-320 can be implemented or performed by a controller, such as the controller 115 of FIGS. 1-2, or by a SIP base station controller.

If, however, the user device is within a service area of a network which does not support voice over packet access according to the predetermined criterion, the call setup/paging request from the mobile switching center is dropped (step 325). Step 325 can be performed, for example, by the controller 115 of FIGS. 1-2. The mobile switching center that transmitted the call setup/paging request then completes and/or processes calls for the user device via a circuit-switched network or access network while the user device is within the service area of a network not capable of supporting voice over packet access (step 330). Data received from a user device is monitored and/or periodically updated to facilitate appropriate signaling when the user device moves from the service area of a network capable of supporting voice over packet access to a network not capable of supporting voice over packet access (and vice versa).

The above-described techniques can be implemented in digital electronic circuitry, or in computer hardware, firmware, software, or in combinations of them. The implementation can be as a computer program product, e.g., a computer program tangibly embodied in a nontransitory information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing a computer program to perform functions of the technology by operating on input data and generating output. Method steps can also be performed by, and apparatus can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Data transmission and instructions can also occur over a communications network. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

The terms “module” and “function,” as used herein, mean, but are not limited to, a software or hardware component which performs certain tasks. A module may advantageously be configured to reside on addressable storage medium and configured to execute on one or more processors. A module may be fully or partially implemented with a general purpose integrated circuit (“IC”), FPGA, or ASIC. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. Additionally, the components and modules may advantageously be implemented on many different platforms, including computers, computer servers, data communications infrastructure equipment such as application-enabled switches or routers, or telecommunications infrastructure equipment, such as public or private telephone switches or private branch exchanges (“PBX”). In any of these cases, implementation may be achieved either by writing applications that are native to the chosen platform, or by interfacing the platform to one or more external application engines.

To provide for interaction with a user, the above described techniques can be implemented on a computer having a display device (e.g., a CRT (cathode ray tube) or LCD (liquid crystal display) monitor or a touchscreen), for displaying information to the user and a keyboard and a pointing device, e.g., a mouse or a trackball, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The above described techniques can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an example implementation, or any combination of such back-end, middleware, or front-end components. The components of the system can be interconnected by any form or medium of digital data communications, e.g., a communications network. Examples of communications networks, also referred to as communications channels, include a local area network (“LAN”) and a wide area network (“WAN”), e.g., the Internet, and include both wired and wireless networks. In some examples, communications networks can feature virtual networks or sub-networks such as a virtual local area network (“VLAN”). Unless clearly indicated otherwise, communications networks can also include all or a portion of the PSTN, for example, a portion owned by a specific carrier.

The computing system can include clients and servers. A client and server are generally remote from each other and typically interact through a communications network. The relationship of client and server arises by virtue of computer programs running on the respective computers and having a client-server relationship to each other.

Various embodiments are depicted as in communication or connected by one or more communication paths. A communication path is not limited to a particular medium of transferring data. Information can be transmitted over a communication path using electrical, optical, acoustical, physical, thermal signals, or any combination thereof. A communication path can include multiple communication channels, for example, multiplexed channels of the same or varying capacities for data flow.

Multiple user inputs can be used to configure parameters of the depicted user interface features. Examples of such inputs include buttons, radio buttons, icons, check boxes, combo boxes, menus, text boxes, tooltips, toggle switches, buttons, scroll bars, toolbars, status bars, windows, or other suitable icons or widgets associated with user interfaces for allowing a user to communicate with and/or provide data to any of the modules or systems described herein.

While the invention has been particularly shown and described with reference to specific embodiments, it should be understood by those skilled in the art that various changes in form and detail may be made therein without departing from the spirit and scope of the invention as defined by the appended claims.

What is claimed is:

1. A telecommunications system comprising:
a controller in communication with a first network capable of carrying voice calls over packet access according to a predetermined criterion and with a second network not capable of carrying voice calls over packet access according to the predetermined criterion;
an interworking module in communication with the first network and the second network, the interworking module facilitating communication of signaling messages between the first network and the second network; and
a location-determination module in communication with the controller and the interworking module for determining when a user device is in a service-area of the first network and when the user device is in a service-area of the second network based on the signaling messages.

2. The system of claim 1, further comprising a session-initiation-protocol interface in communication with the location-determination module and the user device, wherein the location-determination module determines the location of the user device based on session-initiation-protocol messages.

3. The system of claim 1, wherein the location determination module determines the user device is located in the service area of the first network based on a plurality of messages using one or more communications protocols.

4. The system of claim 1, wherein the location determination module determines the location of the user device based on messages received on one or more interfaces in the first or second networks.

5. The system of claim 4, wherein the location determination module is in communication with the one or more interfaces and the one more interfaces comprise at least one of an intermediary session-initiation-protocol node, an interface with an MME node in a packet-based access network, an interface with an HSS/HLR node in an IMS-type network, an interface with a PCRF node in a packet network, or any combination thereof.

6. The system of claim 4, wherein the one or more interfaces comprise at least one of a session-initiation protocol interface, an Rx interface, an Sh interface, an SGs interface, an SLg interface, a non-standard interface, or any combination thereof.

7. The system of claim 1, wherein the location-determination module determines the user device is located in the service area of the first network based on a session-initiation-protocol registration, a radio access technology registration, or a combination of these.

8. The system of claim 1, wherein the interworking module translates messages between a packet-based format and a circuit-based format based on whether the user device is in the respective service area of the first or second network.

9. The system of claim 1, wherein the second network is capable of carrying voice calls over circuit access.

10. The system of claim 1, wherein the location-determination module tracks movement of the user device between the first and second networks.

11. The system of claim 1, wherein the controller comprises the location-determination module.

12. The system of claim 1, wherein the first network comprises a packet-switched access network and the second network comprises at least one of a circuit-switched access network, a packet-switched access network, or both.

13. The system of claim 1, wherein the first network comprises a long-term evolution network and the second network comprises a circuit-switched core network.

14. The system of claim 13, wherein the circuit-switched core network is in communication with a 2G/3G GSM core network, a GSM Edge network (GERAN), a UMTS terrestrial network (UTRAN), an enhanced UMTS terrestrial network (E-UTRAN), or any combination thereof.

15. The system of claim 1, further comprising a mobile switching center in a 2G/3G GSM core network for providing voice packets and data packets to the user device in the service area of the second network, the mobile switching center in communication with the interworking module.

16. The system of claim 1, wherein the system further comprises an application server in communication with the controller.

17. The system of claim 16, wherein the application server is an IP Multimedia Subsystem (IMS) application server.

18. A method for routing telecommunications data including voice packets and data packets between a controller and a user device, the method comprising:
receiving data from the user device;
determining, based on one or more signaling messages, whether the user device is located in a first service area of a first network capable of carrying voice calls over packet access according to a predetermined criterion or in a second service area of a second network not capable of carrying voice calls over packet access according to the predetermined criterion;
interworking signaling messages between the first and second network;
exchanging voice packets with the user device when the user device is located in the first service area of the first network; and
transmitting data packets to a mobile switching center when the user device is located in the second service area of the second network.

19. The method of claim 18, further comprising implementing mobility management functions when the user device is determined to be in the first service area of the first network.

20. The method of claim 18, further comprising monitoring a location of the user device.

21. The method of claim 20, wherein monitoring the location of the user device comprises:
periodically examining received data from the user device;
determining, based on the periodically examined data, whether the user device has moved between the first service area of the first network and the second service area of the second network; and
storing the location of the user device in a memory.

22. The method of claim 21, wherein storing the location comprises storing an identification of an interface on which the data was received.

23. The method of claim 20, further comprising sending an update message to the second network when the user device is determined to have moved between the first service area of the first network and the second service area of the second network.

24. The method of claim 20, wherein monitoring the location of the user device comprises querying a network element capable of communicating with the user device.

25. The method of claim 18, wherein exchanging comprises emulating the mobile switching center.

26. The method of claim 18, wherein the first network comprises a long-term-evolution network and data packets, the voice packets, or both are exchanged with the user device according to a session initiation protocol.

27. The method of claim 18, wherein the second network comprises a radio access network.

28. The method of claim 18, further comprising verifying a location of the user device based on a plurality of messages received from the user device.

29. The method of claim 18, further comprising determining whether the user device has moved from the second service area of the second network to a third service area of a third network not capable of carrying voice calls over packet access according to the predetermined criterion without moving to the first service area of the first network.

30. The method of claim 29, wherein determining whether the user device has moved to the third service area comprises analyzing messages received from the user device or at least one interface.

31. The method of claim 30, wherein the at least one interface comprises at least one of an intermediary session-initiation-protocol node, an interface with an MME node in a packet access network, an interface with an HSS/HLR node in an IMS-type network, an interface with a PCRF node in a packet network, or any combination thereof.

32. The method of claim 18, further comprising aggregating location information based on messages from the user device received over one or more interfaces to the first or second networks, or both.

33. A computer program product, tangibly embodied in a non-transitory computer-readable storage medium, containing instructions operable to cause data processing apparatus to:
receive data from a user device;
determine whether the user device is located in a first service area of a first network capable of carrying voice calls over packet access according to a predetermined criterion or in a second service area of a second network not capable of carrying voice calls over packet access according to the predetermined criterion based on one or more signaling messages;
interwork signaling messages between the first and second networks; and
exchange voice packets with the user device when the user device is located in the first service area of the first network.
